(19) United States
(12) Patent Application Publication
(10) Pub. No.: US 2008/0155264 A1
(43) Pub. Date: Jun. 26, 2008

(54) ANTI-VIRUS SIGNATURE FOOTPRINT

(76) Inventors: Ross Brown, Aliso Viejo, CA (US); Drew Copley, Azle, TX (US)

Correspondence Address: MACPHERSON KWOK CHEN & HEID LLP, 2033 GATEWAY PLACE, SUITE 400, SAN JOSE, CA, 95110, US

(21) Appl. No.: 11/959,270

(22) Filed: Dec. 18, 2007

Related U.S. Application Data
(60) Provisional application No. 60/871,009, filed on Dec. 20, 2006.

(51) Int. Cl. H04L 9/00

(52) U.S. Cl. 713/177

(57) ABSTRACT

A computer anti-virus system is disclosed. The computer anti-virus system can have multiple detection layers and can include a first memory and a second memory. The computer anti-virus system can have a reduced first memory size requirement for a fingerprint signature based anti-virus application program by putting off to the second memory those signatures that are redundantly detected on other layers. Thus, performance can be enhanced and/or costs can be reduced.

### PRIORITY CLAIM

This patent application claims the benefit of the priority date of U.S. provisional patent application Ser. No. 60/871,009, filed on Dec. 20, 2006 and entitled REDUCED ANTI-VIRUS FINGERPRINT SIGNATURE MEMORY FOOTPPRINT (docket no. M-16698-V1 US) pursuant to 35 USC 119. The entire contents of this provisional patent application are hereby expressly incorporated by reference.

### TECHNICAL FIELD

The present invention relates generally to computer software. The present invention relates more particularly to anti-virus software having a reduced signature footprint in fast memory.

### BACKGROUND

Computer viruses are well known. A computer virus is a software program that can infect a computer without the permission (a possibly without the knowledge) of the computer's user. Computer viruses are capable of making copies of themselves such that they can spread from one computer to another.

A computer virus can spread from one computer to another via removable media such as compact discs (CDs) and universal serial bus (USB) drives. Viruses can also spread from one computer to another via a network. Both local area networks (LANs) and wide area networks (WANs, such as the Internet) can transmit viruses.

Anti-virus software is also well known. Anti-virus software is installed upon computers in an attempt to protect them from computer viruses. Anti-virus software is used to identify and remove viruses, preferably before they have any adverse affect upon the computer.

Anti-virus software typically identifies viruses by scanning suspect files to determine if some portion or characteristic of a file matches a virus signature stored in a signature database of the anti-virus software. When a match is found, the file is assumed to contain a virus. Such files can be isolated or quarantined to mitigate the likelihood of them causing harm.

Although such contemporary anti-virus software has proven generally suitable for its intended purpose, contemporary anti-virus software possesses inherent deficiencies which detract from its overall effectiveness and desirability. For example, scanning the files of a computer for a virus can take an undesirably long amount of time. During this time, the ability to use the computer for other purposes can be limited. Also, a virus can cause damage prior its being detected by the scanning process.

As such, although the prior art has recognized, to a limited extent, the problems associated with computer viruses, the proposed solutions have, to date, been ineffective in providing a satisfactory remedy. Therefore, it is desirable to provide anti-virus software that more quickly identifies computer viruses and renders them harmless.

### BRIEF SUMMARY

Systems and methods are disclosed herein to provide an improved anti-virus system. For example, in accordance with an embodiment, an anti-virus system having multiple detection layers and including a first memory and a second memory can have a reduced first memory size requirement for a fingerprint signature based anti-virus application program. This reduced first memory size requirement can be accomplished by putting off to the second memory those signatures that are redundantly detected on other layers. The first memory can have a faster access time than the second memory.

Thus, only those signatures that are necessary for rapid identification of viruses are stored in the first memory. Signatures that are less critical are stored in the second memory.

As a further example, in accordance with an embodiment, a method of a multiple-layer security application program can comprise removing a virus signature from detection by a fingerprint signature anti-virus (AV) layer when the virus is detected by another layer of the security application program different from the fingerprint signature AV layer. In this manner, the efficiency of virus protection is substantially enhanced. Also, A smaller fingerprint signature anti-virus layer can be used, thus permitting the use of a smaller, less expensive, first memory.

The layered security application program can be configured to inspect computer data to determine whether the inspected data is either beneficial or harmful. The application program can include a plurality of protection layers, each layer being defined as any security inspection method including a heuristic based inspection method and/or a signature based inspection method. The signature based inspection method can use an exact match signature and/or a less exact match signature. At least a portion of the application program and any corresponding data can be stored on at least one of two memory devices. The application program and corresponding data can be stored on two or more memory devices of different capacities, speeds, and/or costs in a manner that enhances the speed, efficiency, and/or cost of virus protection.

A computer readable medium can store a computer program for executing the instructions for removing a virus signature from detection by a fingerprint signature Anti-Virus (AV) layer when the virus is detected by another layer of the security application program different from the fingerprint signature AV layer.

By putting off to the second memory those signatures that are redundantly detected on other layers, the performance of the computer system can be enhanced and the cost of the computer system can be reduced.

This invention will be more fully understood in conjunction with the following detailed description taken together with the following drawings.

### BRIEF DESCRIPTION OF THE DRAWINGS

FIG. 1 a block diagram of a computer system and a file server connected through a computer network, in accordance with an example of an embodiment; and

FIG. 2 is a flow chart of a method in accordance with an example of an embodiment.

Embodiments of the present invention and their advantages are best understood by referring to the detailed description that follows. It should be appreciated that like reference numerals are used to identify like elements illustrated in one or more of the figures.

### DETAILED DESCRIPTION

Systems and methods are disclosed herein that provide an anti-virus (AV) fingerprint signature engine having reduced memory and/or processor utilization yielding a reduced anti-virus fingerprint signature memory footprint. For example, a system and method are disclosed where an anti-virus detection engine can remove a virus signature from a primary, high-speed, and/or expensive memory, to a secondary, lower-speed, and/or less expensive memory when the virus is detected by another layer of the AV detection engine, providing improved performance at a lower cost. In this manner, virus detection speed and/or efficiency is enhanced and/or cost is reduced.

In one or more embodiments, the redundantly detected AV signature can be removed from a random access memory (RAM) and placed in a disk memory, such as a magnetic media hard-drive disc. Computer viruses are becoming increasingly prevalent, and a layered approach to security products is increasingly being used to address this growing threat. Initially, an AV system can implement at least one heuristic AV layer along with a fingerprint heuristic layer. Since many systems are putting additional layers of security in a single consolidated product, such as an intrusion prevention system (IPS), buffer overflow protection, various types of heuristics, and a fingerprint AV based system.

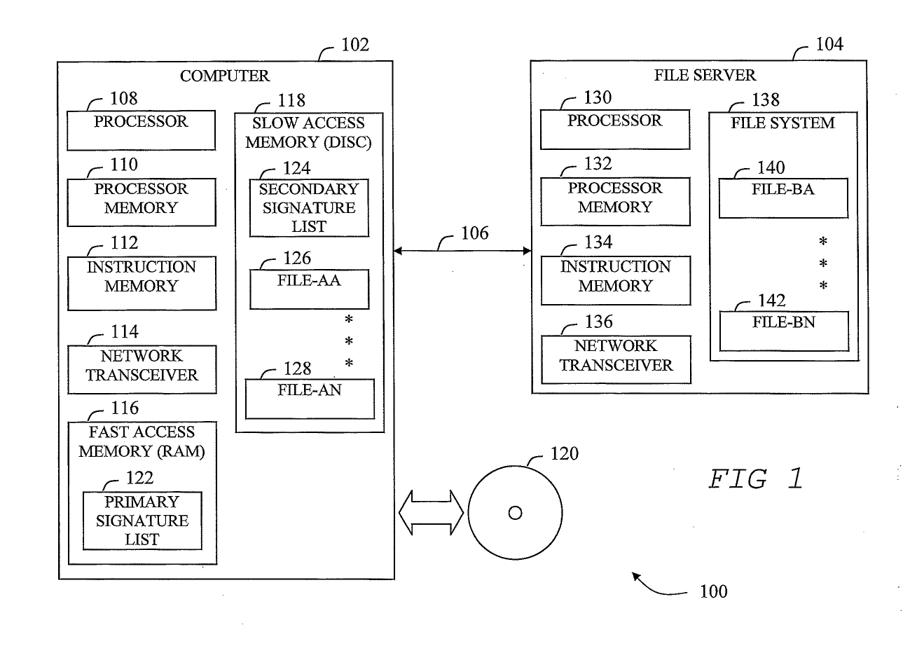

FIG. 1 shows an exemplary computer system 102 and a file server 104 that can communicate with one another through an interconnection network 106. Computer 102 can be a general-purpose computer system such as a desktop, laptop, or rack-mounted computer system, and can include a processor 108, a processor memory 110, an instruction memory 112, a network transceiver 114 for communicating over interconnection network 106, a fast access memory 116, a slow access memory 118, and a removable computer readable media 120 along with a corresponding media read/write device. The computer readable media 120 can comprise media such as a compact disc (CD) or microfloppy disc. The computer readable media 120 can be configured to store data and/or instructions.

Interconnection network 106 can include a connection that facilitates communication via a local area network. Interconnection network 106 can include a connection that facilitates communication via wide area network, such as the Internet.

Processor 108 can be any computer processor, such as a microprocessor, that can execute instructions and operate on data stored within the built-in or external processor memory 110 and/or instruction memory 112. The instructions and/or data can comprise an algorithm to implement some portion of, or all of, an anti-virus fingerprint signature detection engine having reduced memory and/or processor utilization. The instructions can be included on a computer readable medium on which is stored a computer program for executing instructions for implementing a method as shown and described.

Primary or fast access memory 116 can have a relatively fast access time, while secondary or slow access memory 118 can have a relatively slow access time. In this manner, the fast access memory 116 and the slow access memory 118 can include at least one of a random access memory (RAM), a read only memory (ROM), an electronic storage element, a solid-state memory, an optical memory, and a magnetic memory. Fast access memory 116 can have a memory that has a cost per memory storage unit that is substantially higher than that of slow access memory 118. Hence, it can be beneficial to reduce the size and/or cost of fast access memory 116.

Fast access memory 116 can include a primary signature list 122 configured to store and retrieve information related to byte or code sequences or fragments used in signature matching and/or signature analysis. Similarly, slow access memory 118 can include a secondary signature list 124 configured to store and retrieve information related to byte or code sequences or fragments used in signature matching and/or signature analysis. It can be beneficial to store signatures in slow access memory 118 instead of fast access memory 116 in order to reduce costs and/or improve performance. Slow access memory 118 can include a plurality of files, such as file-AA 126 through file-AN 128, that can be examined to determine the presence of a virus or other malware.

File server 104 can be a general-purpose computer system that can be used to receive, store, and/or distribute computer files. The file server 104 can include a general-purpose computer system such as a desktop, laptop, or rack-mounted system, and can include a processor 130, a processor memory 132, an instruction memory 134, a network transceiver 136 for communicating over interconnection network 106, a removable computer media (not shown, but which can be similar to media 120 of computer 102) configured to store and receive data and/or instructions as a file system memory which can include a disc memory.

The file system memory 138 can store and retrieve a plurality of computer files including file-BA 140 to file-BN 142. Processor 130 can be any suitably programmed computer processor, such as a microprocessor, that can execute instructions and operate on data, stored within a built-in or external processor memory 132 and/or instruction memory 134.

Computer 102 can communicate with file server 104 over interconnection network 106 to perform one or more of the operations associated with the disclosed method so that the analysis and anti-virus or malware detection is performed remotely. In this manner, a selected file on a remote computer system can be analyzed to determine if it is harmful or harmless. Alternatively, the analysis can be performed locally on either computer system 102 or the file server 104.

A fingerprint AV layer is the most standard AV layer and is unlikely to become obsolete. Removing the fingerprint AV layer from a malware or virus detection system can be analogous to a crime lab's doing away with a fingerprint or DNA database as part of their criminal investigation process. New virus variations are constantly being produced by ill-intentioned individuals, and so the corresponding signature files associated with such new virus variations continues to grow. This trend presents a serious problem in terms of memory footprint and general system performance.

More specifically, “in memory” requirements can be increased because they can consume considerably more resources to load up these substantially sized lists every time a file is examined from disk. An “in memory” approach can load this list or lists once, and then keep them in memory instead of inducing multiple loads that strain processing and performance and bring in the slow disk system constantly into the equation.

An additional benefit of using a fingerprint AV system, in addition to sheer detection, is that exact virus matches are often wanted or needed in order to practice desirable exact methods of virus removal technique. Since removal techniques can be hazardous even among subtle variants of viruses, it can be important to have an exact match for virus detection whenever possible. Heuristic systems alone can not be enough to provide this “exact match” because, by definition, such systems provide an in-exact or fuzzy match.

As used herein, the term layer can refer to any portion or functionality of an anti-virus security product. Examples of layers include an intrusion prevention system (IPS), a fingerprint-based anti-virus (AV) system, a heuristic-based AV system (of varying types, API sandbox, dynamic, static, etc), and buffer overflow detection/prevention. A fingerprint-based anti-virus system can include any anti-virus algorithm that utilizes “exact match” techniques and specifically can include an AV system that determines a match based on sequences of bytes found within files. The match can be determined either directly or by employing a cryptographic hash methodology for comparison.

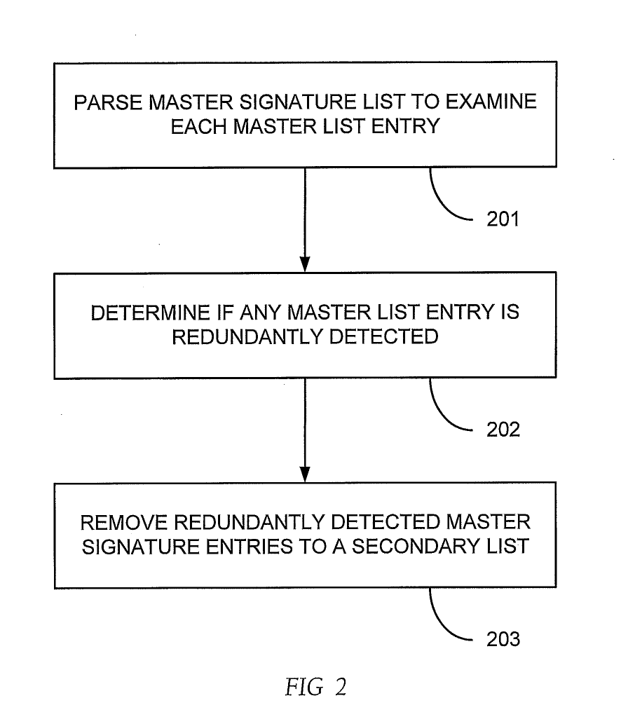

Referring now to FIG. 2, in one or more embodiments, fingerprint AV signatures which are redundant with heuristic and other security layers are removed from the master, “in memory” anti-virus fingerprint system signature list, and then put on a secondary, “on disk” anti-virus signature list. In this manner, a method flow can include the following steps: parse a master signature list to examine each master list entry, as indicated in block 201; determine if any master list entry is redundantly detected, as indicated in block 202; and remove the redundantly detected master signature entry to a secondary signature list, as indicated in block 203.

Signatures that are identified for removal from the “in memory” AV list can be safely removed because other protection layers, for instance, heuristic layers, have been found to redundantly detect the corresponding files and/or their associated viruses. When such a system in ordinary operation, e.g., “in the wild”, encounters a file which has previously been found to be redundantly detected, and so appropriately removed from the “in memory” list and its' signature is then stored on the “on disk” list, the detection layer can activate, or call in, the fingerprint detection system to check the “on disk” list.

In this manner, anytime a file triggers a malware response due to detection in any of the layers of the security product, other than the fingerprint signature layer, the fingerprint AV signature layer system can be activated, or called in, to perform an “on disk” look up procedure. Therefore, one or more embodiments can substantially reduce the “in memory” signature list storage and processing requirements, consequently reducing the “in memory” footprint of the stored list and also reducing the processing requirements for larger “in memory” signature lists.

Benefits of such as system and method include a smaller list size that leads to a smaller amount of storage and/or processing required for the list. This system can be driven from data derived manually or automatically in a variety of methods, including a scanner system that can feed data to this system data encountered while actively parsing a local or remote file system. Further, data can be encountered while doing either periodic or on-demand scans against “in house” malware archives.

Such a system or method can also derive its data from a “neighborhood watch” type of system that operates in real time. Under the “neighborhood watch” implementation model, statistics are delivered from the remote system directly pertaining to what layers of protection have found malware, for the purposes of this system. Other methods can be used to feed such a system; that is, the process of removing signatures from the “in memory” anti-viral list and adding signatures to the “on disk” list. Statistics can be collected from other computers on the same network and/or other computers on different networks. The statistics can represent what files and/or viruses are being detected by layers of an AV system and thus can provide information regard which signatures should be move from one memory to another memory.

The on-disk signature list can be accessed whether or not a token is kept for the malware within the layers that have been found to be redundant for the associated signature for the corresponding malware. More particularly, the on-disk signature list can be called up without using a token specifically indicating an on-disk signature look up.

The word virus as used herein can be defined herein to include any undesirable file, undesirable portion of a file, or malware. Thus, for example, the word virus as used herein can include spyware.

Although the invention has been described with respect to particular embodiments, these descriptions are only examples of the invention's application and should not be taken as limitations. Thus, embodiments described above illustrate, but do not limit, the invention. It should also be understood that numerous modifications and variations are possible in accordance with the principles of the present invention. Accordingly, the scope of the invention is defined only by the following claims.

1. A computer security system comprising multiple detection layers and including a first memory and a second memory, the system having a reduced first memory size requirement for a fingerprint signature based anti-virus application program by putting off to the second memory those signatures that are redundantly detected on layers other than a fingerprint signature layer.

2. The system of claim 2, wherein each memory has an access time, the first memory having a faster access time than the second memory.

3. The system of claim 2, wherein each memory has a cost per memory storage unit, the first memory being more expensive per memory storage unit than the second memory.

4. The system of claim 2, wherein at least one of the first memory and the second memory include at least one of a random access memory (RAM), a read only memory (ROM), an electronic storage element, a solid-state memory, an optical memory, and a magnetic memory.

5. The system of claim 2, wherein the removal of the signatures from an in-memory list in the first memory is accomplished when the removed signatures are considered redundantly detected by other layers.

6. The system of claim 2, wherein a memory footprint is reduced by the removal of at least one fingerprint anti-virus signature from an in-memory list of fingerprint anti-virus signatures.

7. The system of claim 6, wherein the removed signature from the in-memory list is put on the second memory that is accessed only when another layer detects the malware.

8. The system of claim 7, wherein the first memory is a random access memory (RAM) and the second memory is a magnetic disc memory, malware signatures stored in the first memory being considered in-memory signatures, malware signatures stored in the second memory being considered on-disk signatures.

9. The system of claim 8, wherein the on-disk signature list is accessed whether or not a token is kept for the malware within the layers that have been found to be redundant for the associated signature for the corresponding malware.

10. The system of claim 9, wherein the on-disk signature list can be called up without using a token specifically indicating an on-disk signature look up.

11. The system of claim 1, wherein the fingerprint signature detection includes an exact match based on a sequences of bytes found within a files one of directly and by using a cryptographic hash for comparison.

12. A method of a multiple-layer security application program comprising removing a virus signature from detection by a fingerprint signature anti-virus (AV) layer when the virus is detected by another layer of the security application program different from the fingerprint signature AV layer.

13. The method of claim 12, wherein the layered security application program is configured to inspect computer data to determine whether the inspected data is one of beneficial and harmful, the application program including a plurality of protection layers, each layer being defined as any security inspection method including at least one of a heuristic based inspection method and a signature based inspection method, the signature based inspection method using at least one of an exact match signature and a less exact match signature, at least a portion of the application program and any corresponding data being stored on at least one of two memory devices.

14. The method of claim 13, wherein the first layer of the layered security application program is a fingerprint signature AV detection layer.

15. The method of claim 13, wherein the layers include an intrusion prevention system (IPS), a fingerprint anti-virus (AV) layer, a heuristic AV layer, an application programming interface (API) sandbox, a dynamic detection layer, a static detection layer, and a buffer overflow detection layer.

16. The method of claim 15, wherein the detection of redundancy within the anti-virus signature layer is found by at least one of manual testing and automated testing.

17. The method of claim 16, wherein an automated test includes a neighborhood watch implementation model wherein redundancy is detected by continual surveillance.

18. The method of claim 17, wherein the neighborhood watch implementation model includes any automated system for detecting security information from within a system comprising at least one of a stand-alone computer, a central computer, a distributed computer, and a communications network.

19. The method of claim 18, wherein the communications network includes the Internet.

20. The method of claim 19, wherein a redundancy detected by the neighborhood watch implementation model is reported at least one of automatically and manually.

21. The method of claim 19, wherein the neighborhood watch implementation model includes one of detecting and reporting security information to a separate collection system or remotely to a central receiving point.

22. The method of claim 12, wherein the method further comprises:
tracing back from at least one redundant layer of security other then the fingerprint anti-virus system to find a piece of virus;
performing a look up within the on-disk signature list for the found piece of virus; and
providing an alert when a match is found.

23. The method of claim 22, wherein the look up is performed following receipt of a message from the redundant layer.

24. The method of claim 23, wherein the redundant layer performs an exact match look up on the on-disk signature system itself and sends all of the found information directly to the fingerprint anti-virus layer which does not perform a look up operation.

25. The method of claim 24, wherein the fingerprint signature includes exact match criteria for the virus.

26. The method of claim 26, wherein the fingerprint signature includes information for removal of the detected virus.

27. The method of claim 12, wherein the multiple-layer security application program includes a plurality of different applications executing on at least one computer processor.

28. A computer readable medium on which is stored a computer program for executing the instructions for removing a virus signature from detection by a fingerprint signature Anti-Virus (AV) layer when the virus is detected by another layer of the security application program different from the fingerprint signature AV layer.
